(19) United States
(12) Patent Application Publication
(10) Pub. No.: US 2007/0253191 A1
(43) Pub. Date: Nov. 1, 2007

(54) Revolving christmas tree with articulating branches

(76) Inventors: Sye Fu Chin, Diamond Bar, CA (US); John Chin, Diamond Bar, CA (US); Frank Chin, Diamond Bar, CA (US)

Correspondence Address: DAVID J. WILSON, 61 BELCHER CIRCLE, MILTON, MA, 02186, US

(21) Appl. No.: 11/413,253

(22) Filed: Apr. 28, 2006

(51) Int. Cl. F21S 6/00

(52) U.S. Cl. 362/123

(57) ABSTRACT

This invention relates to a revolving, collapsible Christmas tree wherein the branches of the tree are arranged such that they can be folded for storage and returned to a outstretched position for display. This invention also relates to a revolving Christmas tree that incorporates at least two safety devices to prevent the possibility of the drive motor from over heating. Furthermore, the present invention relates to a Christmas tree that incorporates an audio system and a light projection system for the acoustic and visual pleasure of onlookers.

### FIELD OF THE INVENTION

The present invention relates to a collapsible, revolving Christmas tree with articulating branches, audio system, light projection system and dual safety mechanism.

### BACKGROUND OF INVENTION

Christmas trees have long been a tradition during the holiday season. Traditionally, the trees used have been natural trees either cut and placed in a stand or potted for replanting out of doors at a latter time. Later, artificial trees were made out of metals, plastics and/or paper materials. Many of these artificial trees were made to resemble natural trees and many others were made to look different from natural trees. Some of these trees were made of various colors (silver or white, for example), sizes, shapes, etc. Most artificial trees were made to be stored as they were or they were made to have branches removed for storage. Smaller artificial trees had branches made of flexible metal materials to facilitate the folding of the branches for storage. These prior art methods are problematic since branches can be lost or damaged or, in the case of folding branches made of flexible metal, can break off after repeated use with no suitable means for reattachment. Trees with branches that neither fold nor come off take up more space for storage than most people are willing to spare.

Although artificial trees have had many interesting features over the years, these features tend to be limited. Novel features would make artificial Christmas trees visually more interesting and would appeal to those persons that have not purchased currently available artificial trees and, also, that don't like to shop yearly for natural trees or clean-up lost needles that have fallen from natural trees. Artificial Christmas trees have been made of various non-traditional colors or have had colored lights projected onto them from external sources. Some have had small lights incorporated into the branches to take the place of or augment traditional string lights. Some small trees (i.e., sized for placement on a table top or mantle piece) have been made to rotate but this feature has not been incorporated onto large floor model trees because of safety concerns. Such large trees would require a large motor to rotate the tree and if the tree's rotation were to be impeded or blocked the motor may over heat and cause a fire hazard, for example.

What is needed are visually appealing artificial Christmas trees that solve the problems of storage and allow tree rotation in a safe manner.

### SUMMARY OF INVENTION

In one aspect, the present invention relates to a collapsible, revolving (rotating) Christmas tree with articulating (folding) branches for ease of storage and a rotation feature that permits the rotation of the tree while also providing at least two safety mechanisms to prevent over heating of the motor should the tree's rotation be impeded or stopped. In another aspect, the present invention also relates to a Christmas tree that comprises an audio system for the playing of sounds or music and a light projection system for illuminating and decorating the tree. Furthermore, the present invention relates to a revolving Christmas tree with an adjustment mechanism to permit the adjustment of the tension on the tree trunk by the clutch mechanism that is part of the drive mechanism of the tree. In this way the tree can be made to rotate depending on, for example, the size of the tree or the amount of weight on the tree or wear on the system.

The Christmas tree of the present invention may also comprise an advanced optic projection system incorporating, for example, a pattern wave function and an advanced audio playback system. The advanced optic system of the present invention incorporates, for example, LEDs as a light source wherein the LEDs project light through the base unit cover and onto the Christmas tree. Additionally, the audio system of the present invention incorporates, for example, self-contained audio effects and/or plays audio effects from an external source. Further, the base unit provides for the rotation of the Christmas tree driven by a drive system and powered by an electric motor. In a preferred embodiment, the lights, sound and movement of the present invention are synchronized to provide a unified effect for the pleasure of the observer.

### BRIEF DESCRIPTION OF DRAWINGS

FIG. 1 shows a three-dimensional schematic diagram of one exemplary embodiment of the collapsible, revolving Christmas tree of the present invention. The figure shows the branches attached to the trunk of the tree and folded down in the display position. It also shows the trunk inserted into the base unit. It is noted that the schematic diagram of this figure does not show needles or leaves on the branches of the tree for clarity

FIG. 2 shows a three-dimensional schematic diagram of one exemplary embodiment of the collapsible, revolving Christmas tree of the present invention. The figure shows the branches attached to the trunk of the tree and folded down in the display position. In this view the trunk is not inserted into the base unit to show one embodiment of how the end of the trunk is configured for insertion into the base unit. It is noted that the schematic diagram of this figure does not show needles or leaves on the branches of the tree for clarity

FIG. 3 shows a three-dimensional schematic diagram of the components of one exemplary embodiment of how the branches of the tree may be attached to the trunk of the tree.

FIG. 4 shows a close-up view of one section of the tree with branches attached in the open display position.

FIG. 5 shows a close-up view of one section of the tree with the branches folded upwards for storage.

FIG. 6 shows a close-up view of one embodiment of how the branches may be attached to the trunk of the tree.

FIG. 7 shows one embodiment of a view of the base unit of the tree with control buttons and switches, LED lights and tree trunk receptacle visible.

FIG. 8 shows a three-dimensional exploded view of one embodiment of the base unit showing preferred components of the base unit.

FIG. 9 shows a three-dimensional view of the assembled base unit without the base cover.

FIG. 10 shows an embodiment of the tensioning screw both in assembled and exploded views. The exploded view shows the spring and position bead (e.g., a ball bearing) of the tensioning screw of the present invention.

FIG. 11 shows an inverted view of the drive motor and drive plate assembly of the present invention.

### DETAILED DESCRIPTION OF PREFERRED EMBODIMENTS

The invention will now be described in detail with reference to a few preferred embodiments, as illustrated in accompanying Figures. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the Figures and discussions that follow.

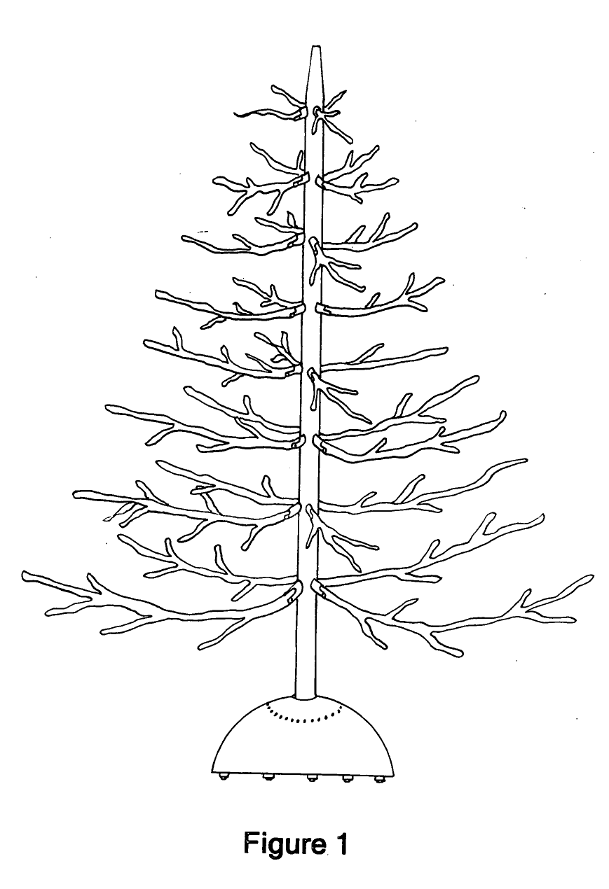

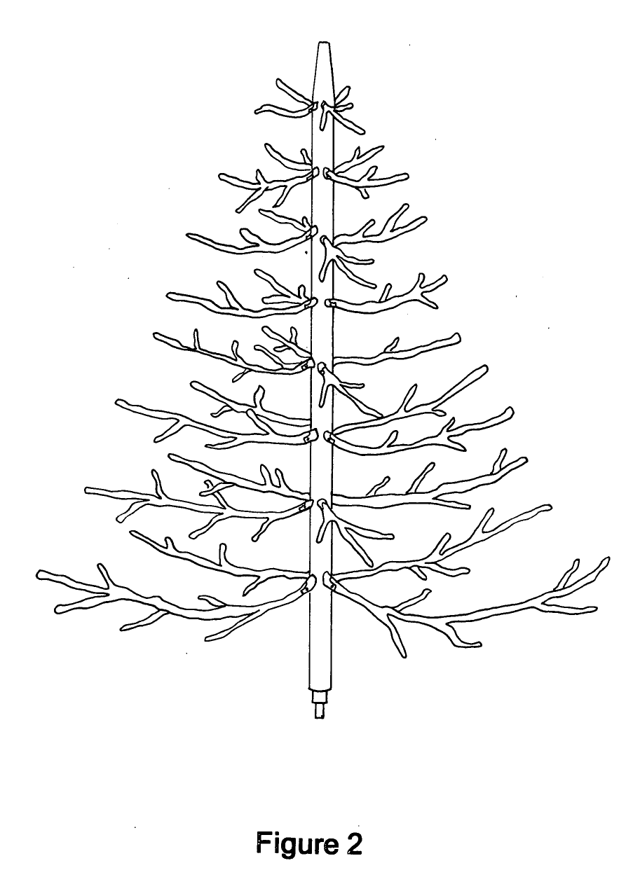

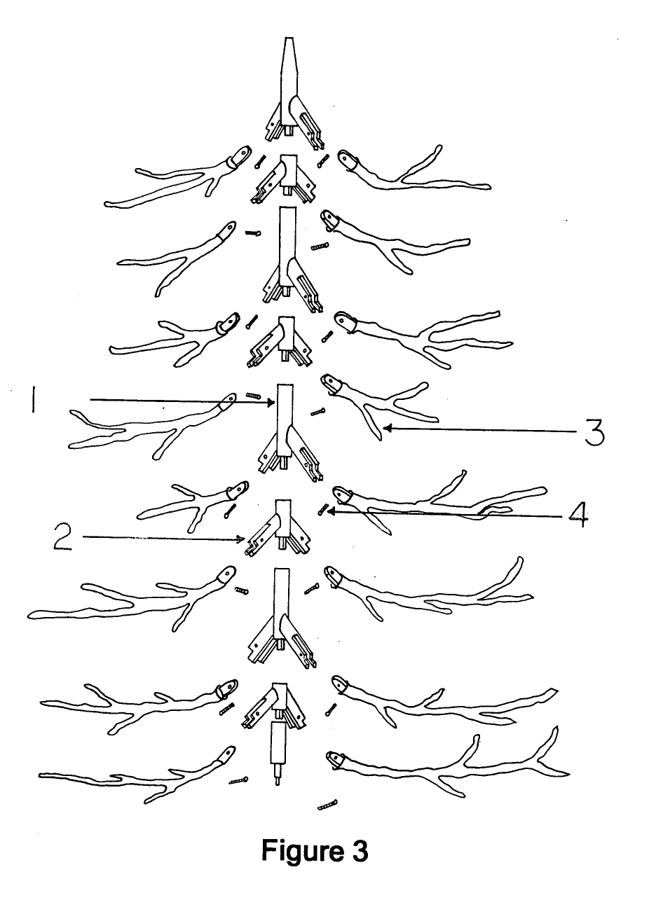

The present invention relates to, in one embodiment, a Christmas tree (see, FIG. 1) with folding (articulating) branches for easy storage and a base unit that provides for the rotation of the tree (see, FIG. 2). FIG. 3 shows an exploded view of the various parts of one embodiment of the tree before assembly at the factory or by the user. The trunk is made of sections 1, connected to each other by connectors 2. The trunk sections 1 and connectors 2 are designed to accept the branches 3 of the tree and which may be attached with pins 4.

In another embodiment, the Christmas tree of the present invention may also comprise an audio system for the playing of sounds or music. In yet another embodiment, the Christmas tree of the present invention may also comprises a lighting system for the projection of light from the base unit to illuminate the tree and for decoration (e.g., to create a visually pleasing display for persons viewing the tree).

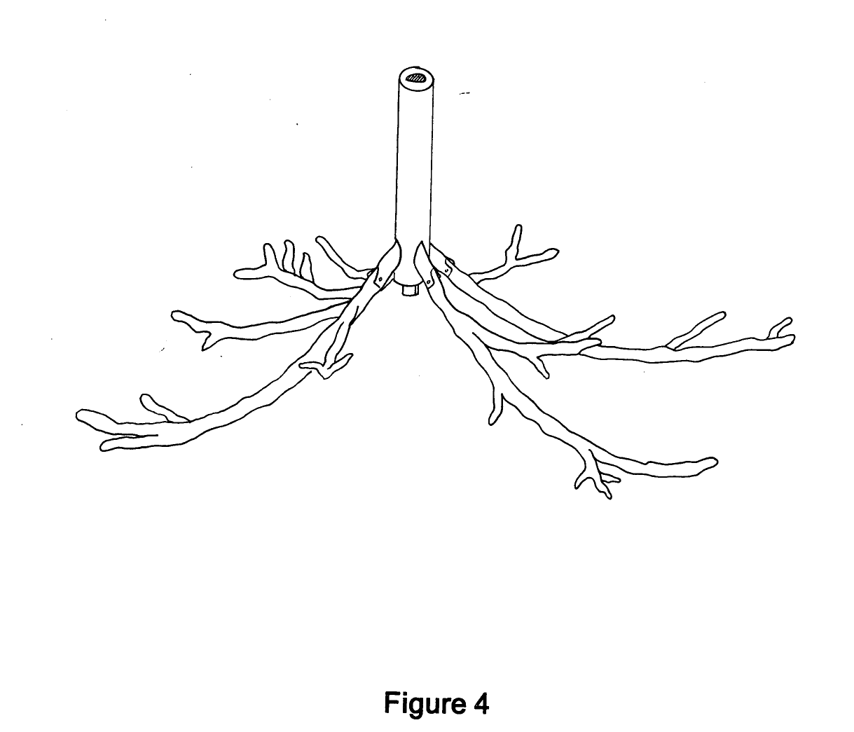

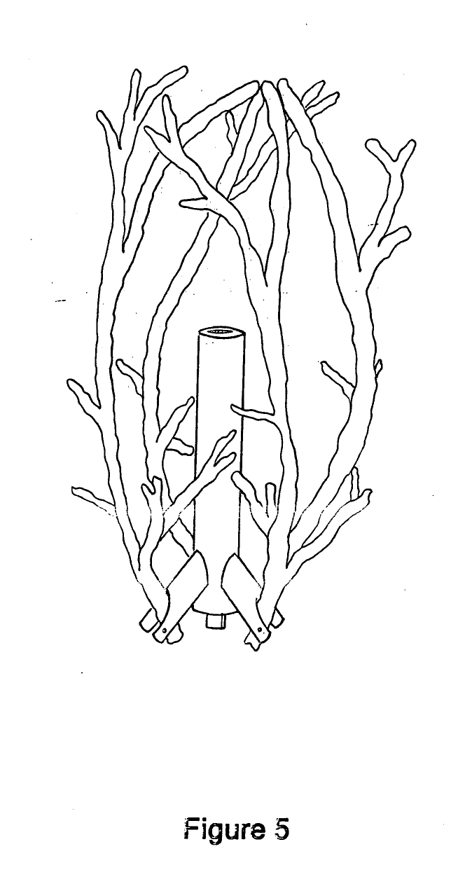

In one embodiment, the Christmas tree of the present invention comprises folding (articulating) branches. The articulating branches of the present invention attach to the trunk of the tree in such a way to permit the folding of the branches in, for example, an upward motion. In another embodiment, the branches may fold in a downward motion. The trunk of the tree is designed to accept the branches of the tree. The attachment points on the tree trunk are positioned such that the branches may fold with minimal or no interference form other branches. FIGS. 4 and 5 show the branches of the tree of the present invention extended and folded, respectively.

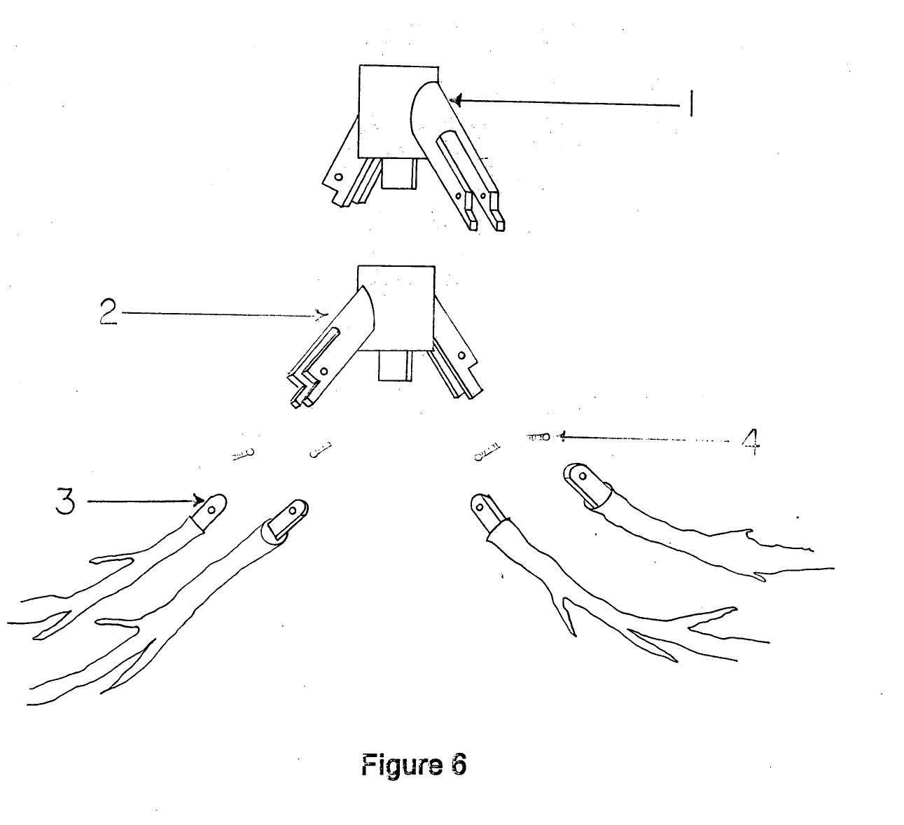

The present invention is not limited to the mechanism used to secure the branches of the tree to the trunk of the tree. FIG. 6 shows a preferred embodiment of how the branches attach to the trunk of the tree. The proximal ends of the branches (i.e., the ends designed to attach to the tree trunk) are flattened to fit between two projections on the trunk and are attached with a pin. The pin may be secured by, for example, a pressure cap or the pin may be a tension pin and, thereby, be self-securing. One skilled in the art will see that other methods may be used to secure the branches of the tree to the trunk of the tree.

The trunk of the Christmas tree of the present invention is designed, for example, to accept the branches of the tree and permit the folding of the branches for storage, certain embodiments of which are described above. The trunk of the Christmas tree of the present invention is also designed to be inserted into the base unit of the tree. In this regard, the end of the trunk is designed to fit into the base unit to keep the tree upright and it is also designed to facilitate the rotation of the tree. The end of the trunk that fits into the base unit meshes with the drive mechanism of the base unit of the tree. The present invention is not limited to the design of the trunk used to facilitate the rotation of the tree. In one embodiment, the end of the trunk is circular and designed with a portion of the end of the trunk made flat. In this way the end of the trunk is “keyed” to fit into the base unit in one way only. This facilitates the rotation of the tree by preventing slipping that may occur if the end of the trunk were, for example, circular. The end of the trunk may also be made in other shapes to serve the same purpose. For example, the end of the trunk that meshes with the drive mechanism of the base unit may be square, rectangular or hexigonical. The present invention may use any shape that ensures the rotation of the tree as long as the shape is configured to mesh with the shape of the drive mechanism of the base unit.

The Christmas tree of the present invention may also comprise a light projection system for projecting lights on to the Christmas tree of the present invention. The light projection system of the present invention would be incorporated into the base unit of the invention. The lights would be projected from the base unit onto the tree from below. The light projection system may incorporate a pattern wave function. A “pattern wave function” is defined herein as a predefined or random sequence of lights to be projected by the light projection system. The pattern wave function may be, for example, synchronized with sounds emanating form the audio system of the present invention. In another embodiment, the lights may stay on continually as long as power is supplied to the lights. In a preferred embodiment, the user would choose if the lights were to stay on continually, utilize a pattern wave function or be projected randomly.

The light projection system comprises light emitting diodes (LEDs) that are located within the base unit. The base unit has a plurality of holes through which light from the LEDs may be projected. It will also be apparent that the invention is not limited by the number of LEDs used to project light from the base unit. In a preferred embodiment, the number of LEDs number from about 4 to about 50. Also, the LEDs of the present invention are not limited to the certain number of colors. The colors many number as few as one or as many as the number of LEDs present in the ornamental device. In a preferred embodiment, the number of colors utilized by the illumination system of the present invention number from 1 to about 8. In one embodiment of the present invention, the lights may be turned on continually. In another embodiment of the present invention, the LEDs may turn on and off in any of a wide number of patterns and sequences. The patterns and sequences of the LEDs are controlled by an electronic control device that may be programmed by the user or may be preprogrammed by the manufacturer, for example.

In another embodiment, the Christmas tree of the present invention comprises an audio system. The audio system comprises a play back circuit board, an optional amplifier and a speaker, a volume resister board and a volume control device. In one embodiment, the audio system is located within the base unit and the base unit may function as a resonant cavity. The audio playback system of the Christmas tree of the present invention may play back sounds selected from analog recordings, digital recordings or a mixture of both analog and digital recordings. In another embodiment, the audio system of the present invention may play back music, voice sounds (e.g., speech and laughing) and/or sounds associated with the Christmas season (e.g., bells, weather sounds). The audio system of the present invention may also have a volume control resister board and a volume control device for user control of the volume of the audio play back. Furthermore, the audio system of the present invention may comprise an input socket for the playing sounds through the Christmas tree that are not preprogrammed in the device. For example, digital sounds may be supplied from compact disks or other electronic audio sources. Analog sounds may be supplied from cassette tapes, vinyl records or the like.

In one embodiment of the present invention, when the Christmas tree of the present invention is powered by an electric power source i) the projection system projects light from said light project from the light projection system, ii) the audio system emits sounds and, iii) said electric motor rotates the trunk of the tree. In a more preferred embodiment, each of these functions can be controlled independently of each other depending on the need and choice of the user.

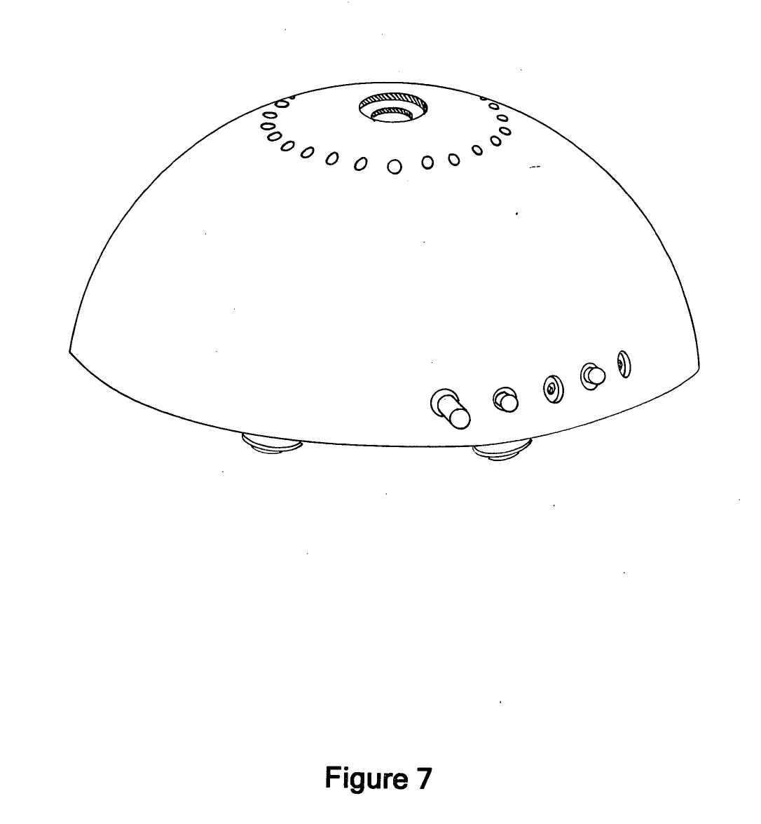

In one embodiment, the base unit (see, FIG. 7) of the present invention serves the function of supporting the tree in an upright position, housing the light projection and audio systems and providing the drive mechanism with which to rotate the Christmas tree of the preset invention. In this regard, the base unit comprises a chassis to which the numerous various components of the invention are housed and attached to. For example, the drive motor of the present invention is mounted to a mounting bracket which, in turn, is attached to the chassis. Likewise, the control board, which provides, for example, user control and provides programming for the audio and illumination systems, is mounted on the chassis either directly or indirectly. The speaker may also be mounted directly or indirectly on the chassis. The chassis may also have holes located adjacently to the speaker to permit sound to emulate form the base unit. The base unit is covered with a removable cover. The cover has holes for both the LED lights and to allow the tree trunk access to the drive mechanism.

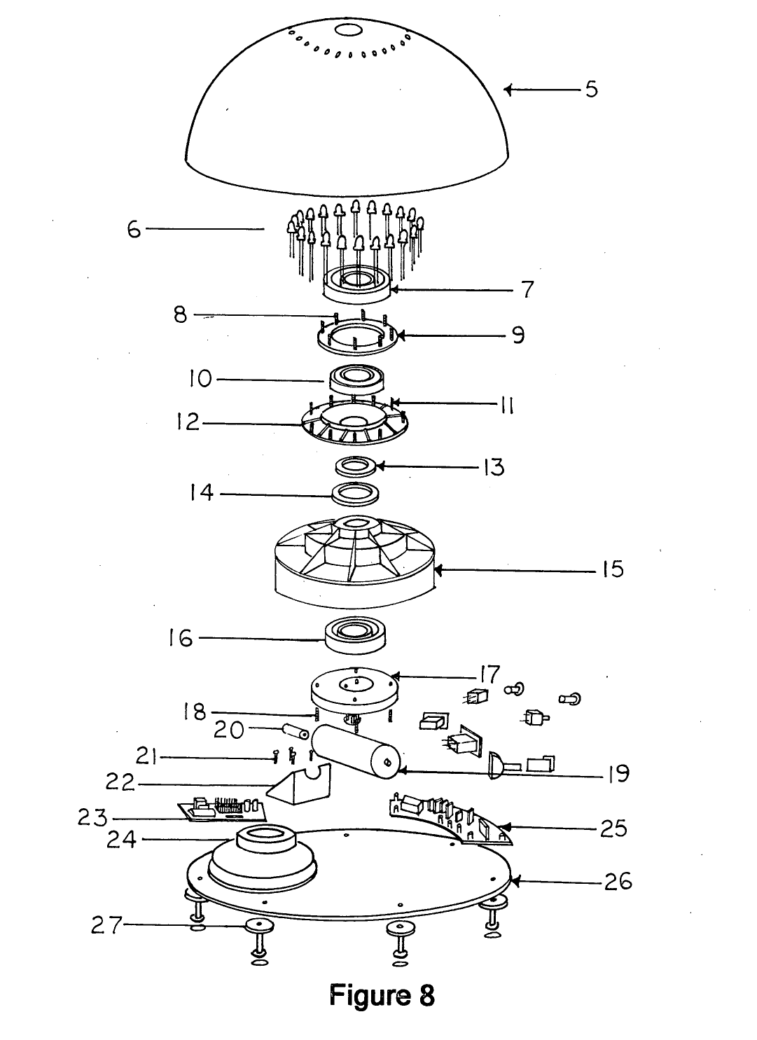

Now, in relation to a non-limiting, exemplary embodiment of the present invention, we will refer to the Figures. We begin by describing a preferred embodiment of the drive mechanism located in the base unit as shown in FIG. 8. FIG. 8 shows an exploded view of the base unit. The base unit is built on a chassis 26. The chassis is supported by feet 27. The number of feet used is adequate to stability support the tree. In a preferred embodiment, the base unit has four feet. The feet of the present invention are adjustable by screwing the feet into or out of threaded holes in the chassis. The threaded holes may also comprise nuts welded or otherwise attached to the chassis. The adjustment of the feet allows for the leveling of the Christmas tree. The electric drive motor 19 is mounted on the drive motor mount 22 that is attached to the chassis with screws 21. When powered, the drive motor turns a drive motor bushing ring 20 that is, in one embodiment, in contact with the drive plate 15. One practiced in the art will see that in certain embodiments is may be desirable to incorporate reduction gears between the shaft of the drive motor 19 and the drive motor bushing ring 20 to regulate the speed of the drive motor bushing ring. Another method contemplated for controlling the speed of the drive motor bushing ring is the use of a resister type speed controller on the drive motor.

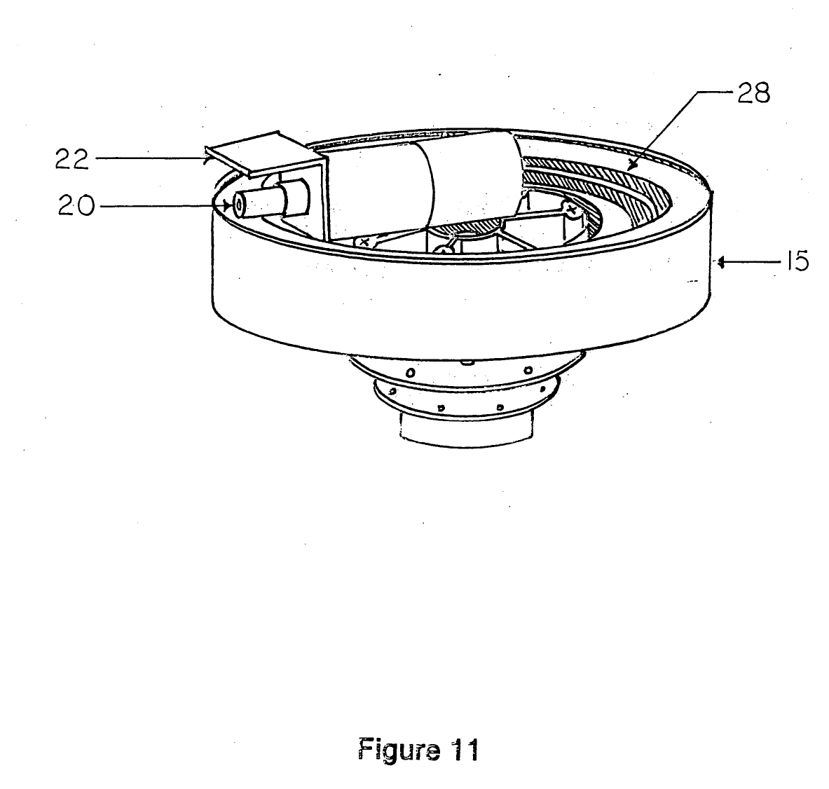

FIG. 11 shows an inverted view of the drive motor mechanism showing the how the drive motor bushing 20 contacts the underside 28 of the drive plate 15. The drive motor bushing ring and the underside 28 of the drive plate 15 may be made of any material that would provide adequate friction to rotate the tree supported by the base unit while at the same time allow for the drive plate 15 to slip on the drive motor bushing ring 20 if the rotation of the tree was impeded or blocked. Examples of such suitable materials are metals such as, for example, bronze, brass, copper and other metals and alloys that are considered to be self-lubricating; carbon and carbon composites; plastics such as, for example, nylon and polyurethane; composite materials such as, for example, metal/plastic composites. In a preferred embodiment, the underside 28 of the drive plate 15 and the motor drive bushing ring 20 are made of polyurethane.

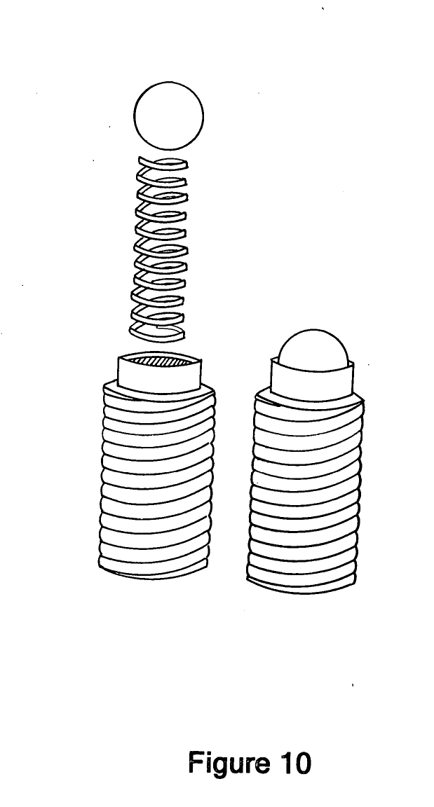

Continuing with FIG. 8, located beneath the drive plate 15, are a bushing 16 and a clutch plate 17 (referred to together as the clutch mechanism). The end of the trunk of the tree is positioned to pass through the bushing 16 and be supported by the clutch plate 17. The bushing is compressed as the clutch plate is tightened to the bottom of the drive plate. The clutch plate 17 is attached to the bottom of the drive plate with a plurality of position bead screws 18 (see, FIG. 10). The position bead screws are designed to permit the adjustment of the tension generated on the bushing and, therefore, the trunk of the tree, as they are tightened and loosened. This adjustment may be necessary depending on the weight of the tree used (different tree models may utilize the same base unit), the weight of the ornaments placed on the tree and to compensate for wear after multiple uses. The clutch mechanism of the present invention is also designed to permit the motor to keep turning if the rotation of the tree is impeded or blocked since the bushing will slip around the tree trunk if any resistance is applied to the tree's rotation. In a preferred embodiment of the present invention, it is contemplated that the position bead screws are adjustable externally of the base unit or are reached easily after the removal of the base unit cover.

The tree trunk is supported above the drive plate 15 by bearings and/or bushings and by holders suitable for holding said bearings and/or bushings. An example of one embodiment of this support mechanism is shown in FIG. 8. As shown in FIG. 8, a bushing or bearing saddle 14 and a bearing 13 are located above the drive plate 15. These support a lower bearing holder 12. The lower bearing is attached to an upper bearing holder 9 with, for example, screws 11. Between the lower 12 and upper 9 bearing holders is a bearing or bushing 10 suitable for supporting the tree in an upright fashion and suitable for allowing the tree to rotate with minimal resistance. A second bearing or bushing 7 may be located above the upper bearing support 9 (held by screws 8) if necessary for adequate support of the tree. One practiced in the art would be able to determine if the additional support was necessary depending on, for example, the weight of the tree or the maximum speed of rotation that could be obtained by the tree. The chassis and associated drive mechanism of the base unit are covered with a removable base unit cover 5 to protect the drive mechanism and provide for a more visually appealing base unit. In one embodiment it is contemplated that the LED lights 6 are located within the base unit cover 5 providing, for example, ease of manufacture and reduced cost of production. In another embodiment, it is contemplated that the LED lights are mounted on a separate support (not shown) positioned to allow the light provided by the LEDs to project through holes in the base unit cover and to provide, for example, easier bulb replacement for the user.

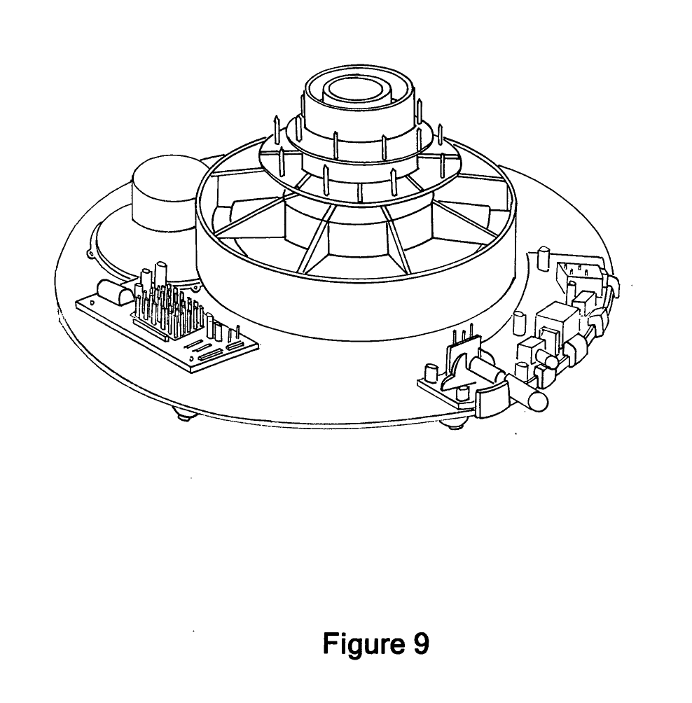

As also indicated in FIG. 8, the base unit of the Christmas tree of the present invention also comprises a control panel 25 including, for example, a power plug for connection to an electrical power source, a power switch for turning the unit on and off, a volume control for adjusting the volume of the audio playback, a control for turning the LED lights on and off or, optionally, changing the lighting sequence (e.g., blinking, steady or random), a socket (optionally) for audio input, and other controls, connections and switches as may be desired by a user. The base unit will also (as indicated in FIGS. 8 and 9) comprise an electronic control board 23 for the coordination of the various functions of the base unit, a speaker 24, amplifier (optional) and other components as are necessary or desired by the user. In another embodiment, the present invention contemplates that the user may control the function of the Christmas tree of the present invention by a remote control device.

In another embodiment of the present invention, the Christmas tree may comprise lights (LED) in the branches of the tree. Power is provided to these lights by power from the base unit that is conducted from the base unit to the lights via wires and contact points where wires are not appropriate. Contact points for the conduction of power to the lights are found, for example, at the pivot points where the tree branches connect to the tree trunk and where the tree trunk connects with the base unit. The contact points for the conduction of power to the LED lights comprise, for example, flat pieces of metal that press against each other even if the pieces of the tree to which they were attached were moved (i.e., the tree branches moved up or down or the tree trunk rotated). Such contact points are embedded into the proximal ends of the tree branches and mounting points for the branches on the tree trunk.

For conduction of power into the tree trunk from the base unit, in one embodiment for example, either the base unit opening or the tree trunk comprises a band of electrically conductive material (e.g., metal) and the other part (base unit opening or tree trunk) comprises, for example, spring mounted ball bearings that contact the metal band and permit the conduction of electricity from the base unit to the tree trunk.

For safety, the amount of power conducted through these contact points is the minimal amount needed for lighting the LED lights and circuit breaker trip switches are incorporated into the device to shut off power in the event of a short circuit. Those practiced in the art will recognize that there are other ways known in the art at the time of filing of this application that can be utilized for the conduction of electrical power through pivotal or rotating devices and these are incorporated herein. Those practiced in the art will also recognize that there are other methods of ensuing the electrical safety of such devices that are known in the art at the time of filing of this application that can be utilized in the present invention and these are also incorporated herein.

FIG. 10 shows one embodiment of the design of the tensioning screw of the present invention. The tensioning screw of the present invention comprises i) a cylinder with a spiral screw design cut into the outer surface of the cylinder, ii) a compressed spring within the cylinder and iii) a ball bearing pressed into the opening of the cylinder wherein said ball bearing is held in place by the compression of the cylinder on the ball bearing and said ball bearing holds the spring under tension within the cylinder. The present invention is not limited to his design of a tensioning screw (or equivalent). Those skilled in the art will recognize that other designs know at the time of filing may be feasible for use in the present invention and such designs are herein incorporated.

The Christmas tree of the present invention may be made of any suitable material or materials. In a preferred embodiment, the Christmas tree is made of plastic. Examples of suitable plastics include, but are not limited to acrylic, polyurethane, polystyrene, polyethylene, polyaminde, polyvinylidene chloride, polyethylene terephthalate, polyester, epoxys, high density polyethylene, polycarbonate, ABS (acrylonitrile butadiene styrene), nylon and vinyl chloride. In other embodiments, certain parts of the Christmas tree of the present invention (for example, parts subject to wear and/or stress or used for the conduction of electricity) may be made of metal. Examples of the parts of the present invention that are suitable for construction from metal include several internal parts such as the chassis 26 and portions of the electric motor 19. Other parts of the Christmas tree of the present invention may be made of the material best suited for that purpose. For example, LEDs would include plastic or glass; control circuit boards would be made of materials including metal, plastic and silicon. One practiced in the art would know the preferred materials for these and other various components of the present invention.

The Christmas tree is not limited to any particular size. The device, for example, may be sized to fit on a table indoors or may be sized to stand on the floor. In a preferred embodiment, the Christmas tree of the present invention is between about 24 inches and 10 feet tall.

What is claimed is:

1. A revolving Christmas tree with folding branches, comprising:
a. i) a plurality of branches, ii) a trunk and iii) a base unit;
b. with each branch of said plurality of branches comprising a proximal end and a distal end, said proximal end comprising a means for attaching said branches to said trunk and permitting the movement of the branches in an essentially vertical manner from an essentially outstretched position to an essentially upright position and back;
c. said trunk configured to accept said proximal ends of said branches arranged in such a manner to permit the vertical movement of said branches from an essentially outstretched position to an essentially upright position and back and wherein said trunk comprises an end configured to be placed in said base unit;
d. wherein said base unit comprises i) an opening for accepting said trunk, ii) a drive mechanism for revolving said trunk, said drive mechanism for revolving said trunk comprising a clutch mechanism wherein the trunk is in contact with said clutch mechanism and said clutch is driven by friction from a drive plate and, wherein, said drive plate is driven by friction from a drive motor, iii) an audio system and, iv) a light projection system for projecting light onto said Christmas tree, said light projection system comprising light emitting diodes (LEDs).

2. The Christmas tree of claim 1, wherein said base unit further comprises a mechanism for adjusting the tension of the mechanism for revolving said trunk on said trunk.

3. The Christmas tree of claim 1, wherein said means for attaching said branches to said trunk comprises a pivotable joint.

4. The Christmas tree of claim 1, wherein said means for attaching said branches to said trunk comprises a friction fitting.

5. The Christmas tree of claim 1, wherein said branches comprise synthetic needles or leaves made to resemble natural needles or leaves.

6. The Christmas tree of claim 1, wherein said branches comprise synthetic needles or leaves made to not resemble natural needles or leaves by comprising a non-natural color and/or shape and/or by comprising a decoration.

7. The Christmas tree of claim 1, wherein said light emitting diodes emit one or more colors of light.

8. The Christmas tree of claim 1, wherein said clutch is adjusted such that it will slip if said trunk is at least partially impeded or blocked from rotating.

9. The Christmas tree of claim 1, wherein said drive motor will slip on said drive plate if said trunk is at least partially impeded or blocked from rotating.

10. The Christmas tree of claim 1, wherein said base unit additionally comprises an audio input socket.

11. The Christmas tree of claim 1, wherein said drive motor, light system and audio system are electronically controlled.

12. The Christmas tree of claim 1, wherein said drive motor, light system and audio system is controlled by a remote control.

13. A base unit for revolving an item attached to said base unit, comprising:
a. an opening for accepting said item;
b. a drive mechanism for revolving said item, said drive mechanism for revolving said item comprising a clutch mechanism wherein the item is attached to said clutch mechanism and said clutch mechanism is driven by friction from a drive plate and, wherein, said drive plate is driven by friction from a drive motor and wherein if the rotation of said item is at least partially impeded or blocked, said clutch mechanism and/or said driver plate will slip preventing the overheating of said drive motor.

14. The base unit of claim 13, wherein said base unit additionally comprises a mechanism for adjusting the tension of said clutch mechanism on to said item to be rotated.

15. The base unit of claim 13, wherein said item is an artificial Christmas tree.

16. The artificial Christmas tree of claim 14, wherein said artificial Christmas tree is designed to fit into said base unit.

17. The artificial Christmas tree of claim 14, wherein said artificial Christmas tree comprises folding branches.

18. The base unit of claim 10, wherein said base unit additionally comprises an audio system and a light projection system for projecting light onto said item, said light projection system comprising light emitting diodes (LEDs).

19. A revolving Christmas tree with folding branches, comprising:
a. i) a plurality of branches, ii) a trunk and iii) a base unit;
b. with each branch of said plurality of branches comprising a proximal end and a distal end, said proximal end comprising a means for attaching said branches to said trunk and permitting the movement of the branches in an essentially vertical manner from an essentially outstretched position to an essentially upright position and back wherein said means for attaching said branches to said trunk comprises a pivotal joint and a friction fitting;
c. said trunk configured to accept said proximal ends of said branches arranged in such a manner to permit the vertical movement of said branches from an essentially outstretched position to an essentially upright position and back and wherein said trunk comprises an end configured to be placed in said base unit;
d. wherein said base unit comprises i) an opening for accepting said trunk, ii) a drive mechanism for revolving said trunk, said drive mechanism for revolving said trunk comprising a clutch mechanism wherein the trunk is in contact with said clutch mechanism and said clutch is driven by friction from a drive plate and, wherein, said drive plate is driven by friction from a drive motor and wherein if the rotation of said item is at least partially impeded or blocked, said clutch and/or said driver plate will slip preventing the overheating of said drive motor, iii) an audio system and, iv) a light projection system for projecting light onto said Christmas tree, said light projection system comprising light emitting diodes (LEDs).

20. The Christmas tree of claim 19, wherein said Christmas tree is an artificial Christmas tree and said Christmas tree is keyed to fit into said base unit.
